(19) United States
(12) Patent Application Publication
(10) Pub. No.: US 2006/0129448 A1
(43) Pub. Date: Jun. 15, 2006

(54) Life management skills enhancement program

(76) Inventor: Trevor Smith, Victoria (AU)

Correspondence Address: KOLISCH HARTWELL, P.C., 200 PACIFIC BUILDING, 520 SW YAMHILL STREET, PORTLAND, OR, 97204, US

(21) Appl. No.: 11/193,175

(22) Filed: Jul. 29, 2005

Related U.S. Application Data
(63) Continuation of application No. 09/766,256, filed on Jan. 18, 2001.

(30) Foreign Application Priority Data
Jan. 18, 2000 (AU) PQ5147

(51) Int. Cl. G06F 11/34

(52) U.S. Cl. 705/11

(57) ABSTRACT

A life management skills enhancement program (1) is designed to provide life management and vocational skills to young people

The program (1) includes a sub-program of curriculum-based activities (1.1), which activities in turn include physical activities (1.1.1) and intellectual activities (1.1.2).

There is a funding sub-program (1.2) which operates with the aim of making the program self-funding.

There is a linking sub-program (1.3), which links together all the organisations and other entities which are part of the program (1).

The program (1) also includes a youth club, which provides a television show (1.4.1), a print magazine (1.4.2) and a computer networking program (1.4.3).

### CROSS-REFERENCE TO RELATED APPLICATIONS

This application claims priority to U.S. patent application Ser. No. 09/766,256, filed Jan. 18, 2001, which claims priority to Australian Provisional Patent Application Serial No. PQ5147, filed Jan. 18, 2000, both entitled “Life Management Skills Enhancement Program”.

### RELATED APPLICATIONS

This application claims priority to Australian Provisional Patent Application for “LIFE MANAGEMENT SKILLS ENHANCEMENT PROGRAM” filed on 18 Jan. 2000.

### TECHNICAL FIELD OF THE INVENTION

The present invention relates to providing life management and vocational skills, particularly to young people.

### BACKGROUND ART

The pace of life in industrialised societies moves at an ever-faster rate. The accelerating rate of change in modern society places ever increasing pressures on people to deal with an already vast, and steadily increasing, array of challenges and demands.

These increasing pressures are exacerbated by other changes in society, which include, but which are not limited to, the following.
The breakdown of the network of the extended family.
The reduced participation in organised churches or religions, which historically in Western societies have developed individuals' values and beliefs.
The reduced participation in organised club structures.
The growth in awareness of individual rights, to the perceived detriment of the general spirit of cooperation and consensus.
Changing lifestyles and a more affluent society have reduced both the caring for others and the respect for the assets and material possessions of others.

Young people and their families have had to absorb more of these pressures, without being given knowledge or skills to cope with them.

The consequences have been increasing prevalence in suicide, crime, substance abuse and a range of other youth and family problems. The more subtle of these include destructive behavioural patterns such as depression, isolation, stress and lack of values.

Often these issues have been dealt with individually with initiatives implemented for each particular problem. However, this tends to create a response framework which is fragmented and uncoordinated.

A number of vocational and enterprise education programs exist, but generally all are employment-based.

Thus, there is a need for integrated solutions for motivating young people to deal with the demands of life with tenacity, creativity and optimism.

In addition, there is a need for a focused, comprehensive framework for enhancing the life management skills of young people.

### SUMMARY OF THE INVENTION

The present invention accordingly provides a life enhancement program for enhancing the life management skills of young people, which program includes:
a curriculum-based sub-program of activities for young people, which sub-program is integrated into the curriculum of at least one educational institution;
a youth club sub-program for young people;
a funding sub-program; and
a linking sub-program which maintains links with organisations which are external to the life enhancement program,
   and wherein the program further includes a management organisation which integrates the sub-program of activities, the youth club sub-program, the fund-raising sub-program and the linking sub-program.

### PREFERRED FEATURES OF THE INVENTION

It is preferred that participants in the program enter the program at kindergarten level. However, irrespective of the age of a participant, it is particularly preferred that the participant's family also participates in the program and that the program continues to operate outside standard school hours.

It is preferred that the program is administered by a foundation operating in the form of a board of trustees under a trust deed.

It is preferred that the trustees of the trust be advised by a number of boards of advisers, in which the members of each board represent interest groups or have relevant expertise.

It is especially preferred that the program is community-based at a local level so that participants in the program can be aware of the activities of each sub-program.

It is preferred that the curriculum-based sub-program includes at least two streams of sub-programs. When there are two streams of sub-programs, it is preferred that one of these streams be based on physical activity and that one of these streams be based on intellectual activity.

It is preferred that the activities within the curriculum-based sub-programs are provided by a network of participating member organisations which includes:
educational institutions;
sporting organisations;
business organisations;
service organisations;
recreational organisations; and
external training providers.

It is preferred that the intellectual activity stream offer activities chosen from the group consisting of scientific pursuits, mathematical pursuits, business pursuits, creative pursuits and artistic pursuits.

A particularly preferred activity in the intellectual activity stream is a “Future Makers” activity in the form of a partnership between an educational institution and at least one business organisation in which student teams work in schools and in the business environment to develop new products.

It is preferred that the physical activity stream offer sporting activities chosen from the group consisting of fishing, basketball, netball, tennis, golf, cycling and running.

It is especially preferred that the fishing activity include a “Hooked on Fishing™” sub-program for equipping young people with the knowledge and skills to participate in recreational fishing. It is especially preferred that the “Hooked on Fishing™ sub-program” includes elements of:
recruiting volunteers;
training those community volunteers to train and coach young people in fishing related knowledge and skills; and
the coaching of young people in fishing related knowledge and skills.

It is preferred that the volunteers include:
teachers; and
community volunteers.

It is preferred that the youth club sub-program includes the elements of:
a communication medium, such as a television series and/or a print magazine; and a computer network based program.

Alternative preferred forms of computer network for providing the network based element include the Internet, and one or more intranets.

It is preferred that the funding sub-program includes a network of sponsorships. The young people who participate in the life enhancement program according to the present invention are encouraged to obtain sporting and other equipment from dealers in the network of sponsorships, and in turn dealers in the network of sponsorships contribute to the funding of the program. The funds so contributed are paid to the foundation for the purposes of the trust.

It is further preferred that the fund-raising sub-program includes the distribution of funds by the trustees to participating member organisations.

According to alternative preferred forms of the invention, any one or more of the functions of:
providing administrative support within the foundation;
developing curriculum-based sub-programs;
acquiring curriculum-based sub-programs from external sources; and
providing services to the foundation for the purpose of the youth club are performed for the foundation by at least one external organisation.

### BRIEF DESCRIPTION OF THE DRAWINGS

FIG. 1 is a chart showing the sub-programs that are included in a life management skills enhancement program according to one embodiment of the present invention.

FIG. 2 is a top-level organisational chart showing the organisational structure that implements the present invention according to the embodiment of FIG. 1.

FIGS. 3 and 3a illustrate two specific examples of the structure and organisation of an intellectual activity sub-program.

FIG. 4 illustrates a specific example of a physical activity sub-program.

FIG. 5 is a chart of the income, partnerships, process, and outcomes of the program of the present invention.

FIG. 5a is a chart detailing the outcomes of the program of the present invention.

FIG. 6 is a chart detailing an intellectual activity for applying inventive thinking to develop new products.

FIG. 7 is a chart of connections between organizations in a physical activity sub-program.

FIG. 8 illustrates a flowchart for the purchase of a product that is sponsored under the program.

FIG. 9 is a chart of strategy for the present invention.

Preferred embodiments of the invention are described with reference to the drawings.

### DESCRIPTION OF PREFERRED EMBODIMENTS OF THE INVENTION

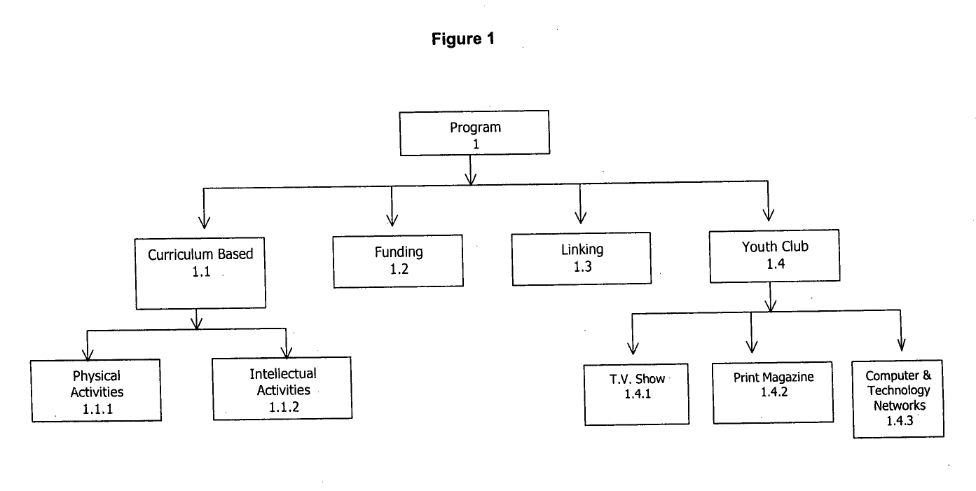

As shown in FIG. 1, a preferred embodiment of the program of the present invention includes a curriculum-based sub-program 1.1, a fund-raising sub-program 1.2, a linking sub-program 1.3 and a youth club 1.4.

The Sub-programs

The Curriculum-based Sub-program

The curriculum-based sub-program 1.1 includes a physical activities sub-program 1.1.1 and an intellectual activities sub-program 1.1.2.

Physical Activities

The “Hooked on Fishing™” sub-program is an example of a physical activities sub-program that is available to participants. It is inspired by, and a modification of, the “Hooked on Fishing, Not on Drugs” program of the American Sportfishing Association.

The Hooked on Fishing™ sub-program is made available to young people. It is preferred that this sub-program be run in educational institutions by trained volunteers from the recreational fishing organisations. As described in more detail below with reference to the funding sub-program 1.2, those educational institutions and recreational fishing organisations in turn benefit from the funding program 1.2.

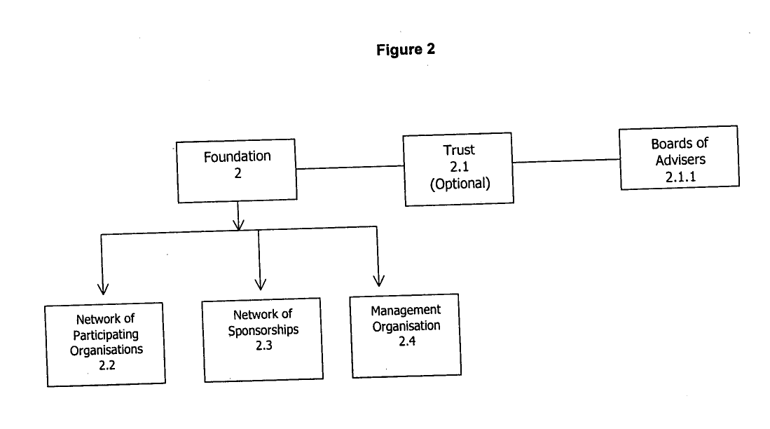

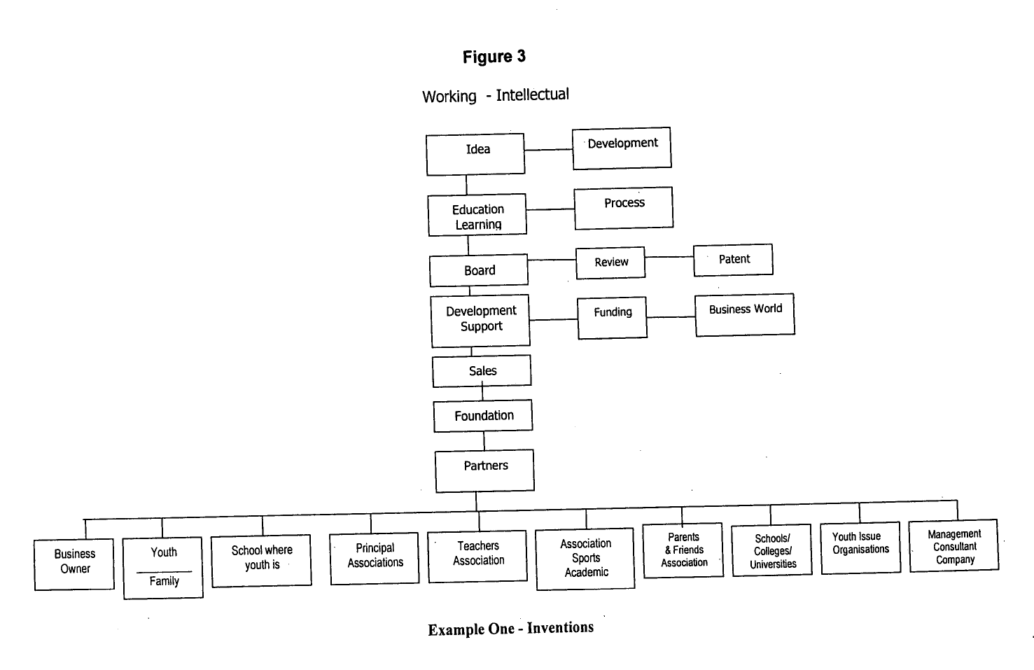

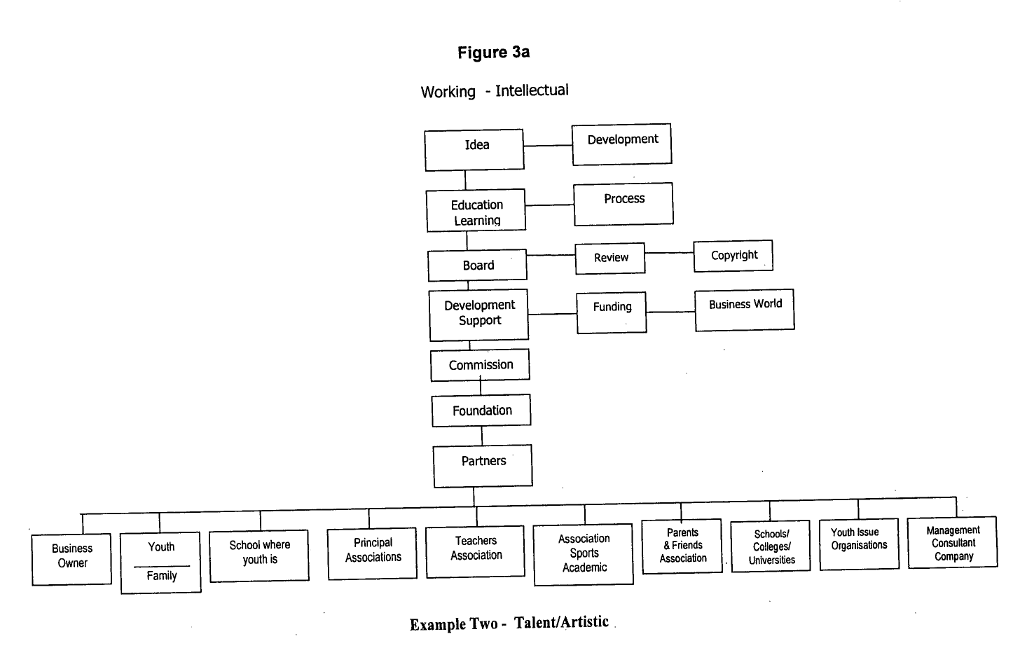

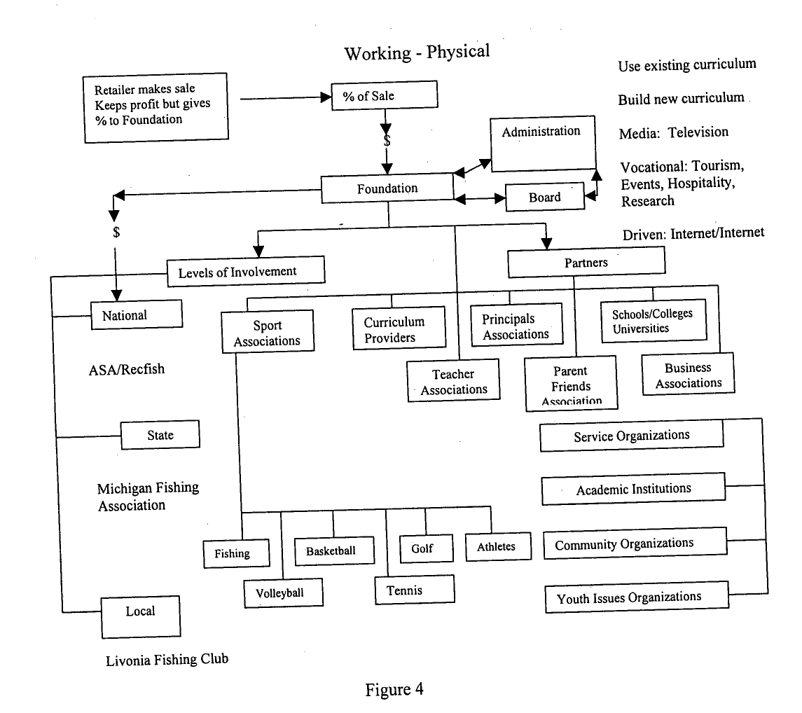

It is also preferred that the young people who participate in the Hooked on Fishing™ sub-program, and their families, are encouraged to obtain fishing tackle, bait and the like from dealers in the network of sponsorships which is described below with reference to FIG. 2 of the drawings.

Intellectual Activities

The “Future Makers™” sub-program is an example of an intellectual activities sub-program that is available to participants. The Future Makers™ sub-program is an initiative of the Oregon Graduate Institute of Science and Technology.

Future Makers™ operates in schools. The processes involved are as follows.
Businesses contribute employee time to serve as mentors to student invention teams.
Students visit the partner business and apply their inventive thinking skills in the business setting.
Working in small teams with their mentor, they identify problems or needs that can be addressed by inventive thinking.
Back at school mentors continue to assist the students with inventions development.
Students develop a visual display and oral presentation to communicate their ideas.
Students learn how to trade mark and patent their inventions.
If they believe it appropriate, trade mark or patent applications are lodged.
The program culminates with an Invention Convention where students present their ideas in a science-fair type event.
Business mentors participate as judges or reviewers, in providing awards and recognition for student work.
Students market their inventions.

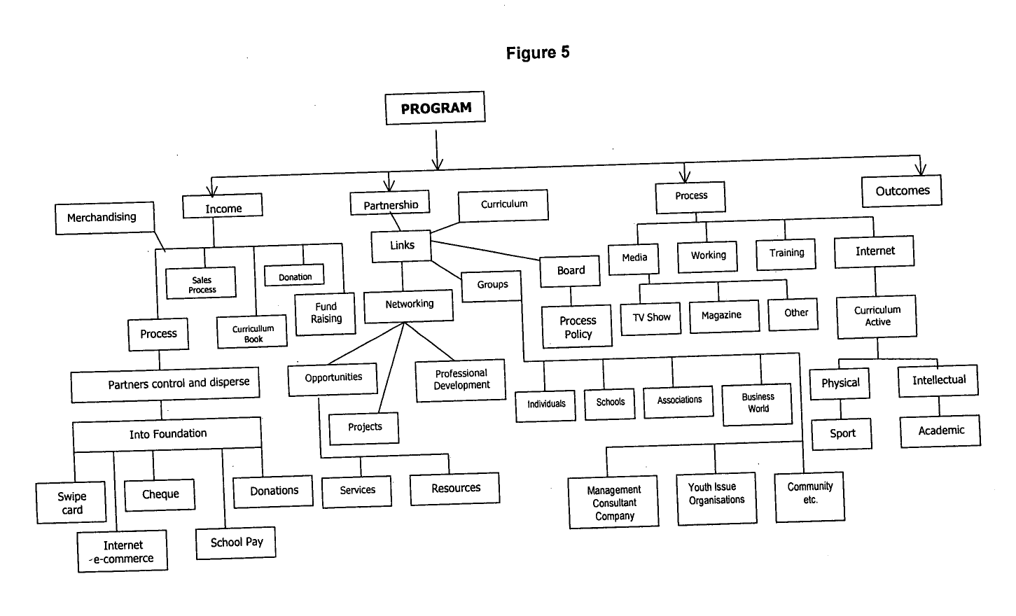

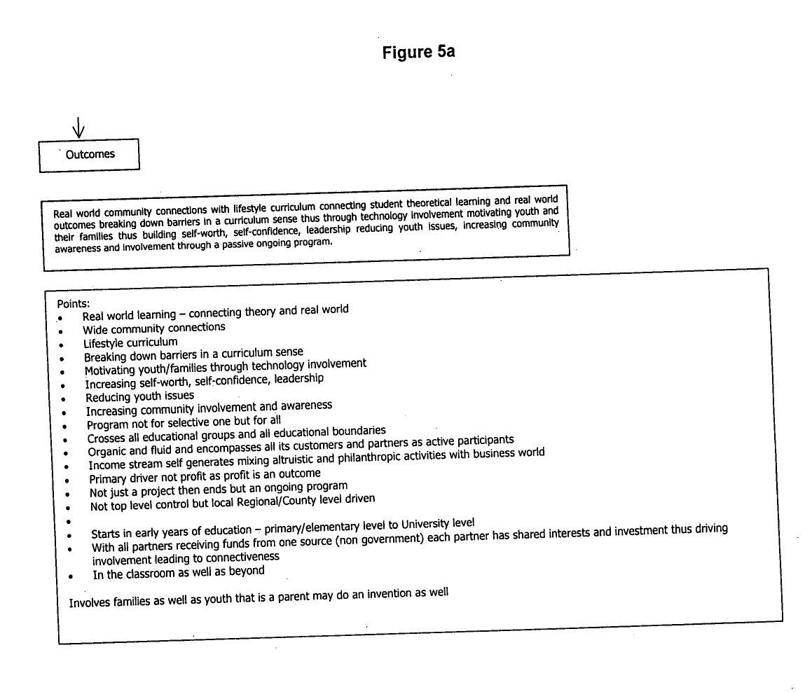

This process is summarised in FIG. 5.

The Funding Sub-program

As shown in FIG. 1, the program also includes a funding sub-program 1.2.

The funding program 1.2 raises funding from all feasible sources, including government grants. However a primary aim of the funding sub-program 1.2 is to raise funding through the network of sponsorships which is described below with reference to FIG. 2.

The Linking Sub-program

As shown in FIG. 1, the program also includes a linking sub-program 1.3.

The linking sub-program 1.3 links the organisations and other entities which are part of the program.

These organisations and entities include the following.
Service organisations, which may contribute to the program by providing funding, personnel or other resources;
Manufacturers and retailers who may contribute to the program:
   by supplying goods or services to the young people who participate, and
   by sponsoring the program by returning a percentage of the value of those goods and services to the foundation.
Business associations which contribute personnel or resources to the program.
Sporting associations which contribute personnel or resources to the program.
Sponsors who otherwise contribute funding, personnel or other resources.
Educational institutions (including the teachers, students and parents) which participate in the program.
Support groups of the educational institutions.
Associations of teachers, particularly the associations of principals of schools and colleges.
The youth club which is described below with reference to the sub-program 1.4.

The Youth Club Sub-program

As shown in FIG. 1, the program also includes a “Youth club” sub-program 1.4.

The youth club sub-program 1.4 serves primarily to:
provide a set of resources to the young people who participate in the program; and
publicise the activities of those young people.

According to the embodiment of the invention which is shown in FIG. 1, the youth club 1.4 in turn consists of a television show 1.4.1, a print magazine 1.4.2 and a computer network based resource 1.4.3.

It is preferred that the television show 1.4.1 be a nation wide, and cater for children aged 10-18. This television show showcases the talent, achievements and endeavours of young people. The running of the show depends heavily on input from youth club members of an older age bracket, that is 13-18.

There are opportunities within the television show for youth training in such areas as administration, funding and promotion, script writing, use of technology, human resources and finances that will significantly enhance each participant's employment opportunities.

It is preferred that the magazine 1.4.2 be a glossy magazine for children which is distributed to all participating groups in the program. The content of the magazine 1.4.2 is gathered via the computer network 1.4.3 which is described below.

The content of the magazine 1.4.2 is broader than the television show 1.4.1, and encompasses many youth related issues.

All youth club members have the opportunity to contribute to the content, editing and administration of the magazine 1.4.2. The magazine 1.4.2 according to the present invention is widely available at newsagents in order to gain wide exposure and recognition.

The Computer Networking Sub-program

As shown in FIG. 1, the program also includes a computer networking sub-program 1.4.3.

The computer networking sub-program 1.4.3 is preferably provided by the Internet and a series of intranets.

The functions of the computer networking sub-program 1.4.3 include the following.
It provides access to educational material and other learning resources.
It provides links to other independent clubs, activities and associations.
It provides a resource for communication between youth club members.
It showcases the activities of youth club members.
It provides on-line competitions.

Members of the youth club in addition have the opportunity to buy quality products and to access services at a reduced rate that will assist them in the curriculum-based sub-programs.

The Organisational Structure

FIG. 2 is a top-level organisational chart showing the organisational structure which implements the present invention according to the embodiment of FIG. 1.

The Trust

As shown in FIG. 2, the foundation 2 is administered by a board of trustees 2.1 under a deed of trust.

The Boards of Advisers

According to the embodiment of the invention which is illustrated in FIG. 2, the trustees are advised by a number of boards of advisers. The members of each board of advisers either represent interest groups or have relevant expertise in the area of concern to that board.

The Network of Participating Organisations

As shown in FIG. 2, the foundation 2 operates in conjunction with a network of participating organisations 2.2. The organisations within this network of participating organisations includes:
educational institutions;
sporting organisations;
business organisations;
service organisations;
recreational organisations; and
external training providers.

The Network of Sponsorships

The foundation 2 also operates in conjunction with a network of sponsorships 2.3.

The young people who participate in the life enhancement program according to the present invention are encouraged to obtain sporting and other equipment from dealers in the network of sponsorships 2.3. In turn, dealers in the network of sponsorships contribute to the funding of the program. The funding which is generated by the network of sponsorships 2.3 is in turn put into the foundation and distributed by the board of trustees 2.1. Recipients of this funding may, at the discretion of the trustees, include the following:
The educational institutions (schools, colleges and the like) in which the young people participate in curriculum-based activities. This funding is then used on training/management to assist young people.
The sporting associations, clubs and the like within the network of participating organisations 2.2 which contribute to the running of the program. This funding is then used on training/management to assist young people.
The associations of principals, teachers and the like which are within the network of participating organisations 2.2. This funding is then used to meet the costs of principals or other teachers undertaking professional development. This professional development takes place within business
enterprises, and in training in management to assist young people.
The trustee board 2.1. This funding is used to meet the running costs of the board of trustees.
The management organisation 2.4. This funding is then used to meet the expenses of the management of the overall program by the management organisation.

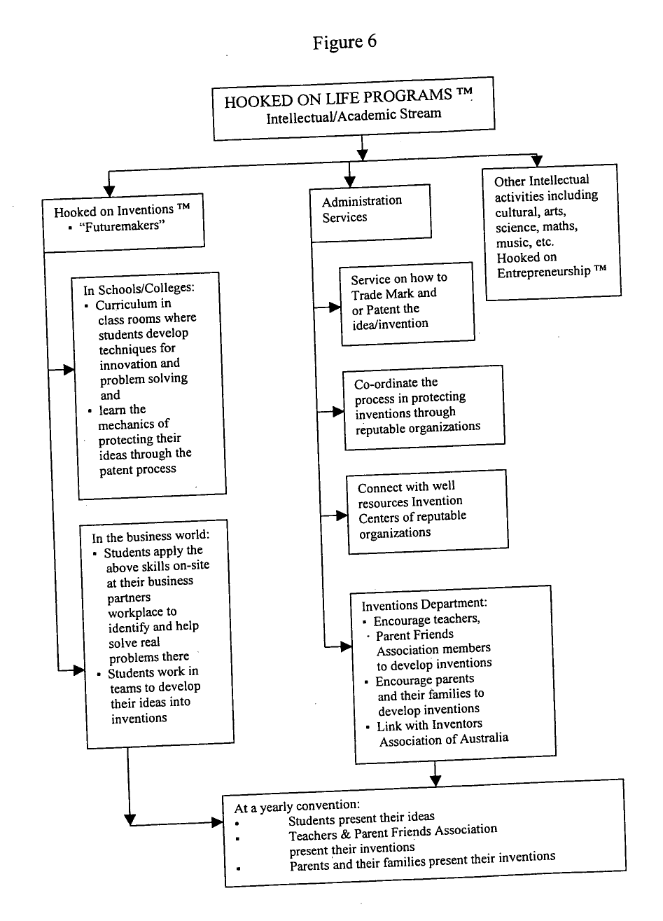

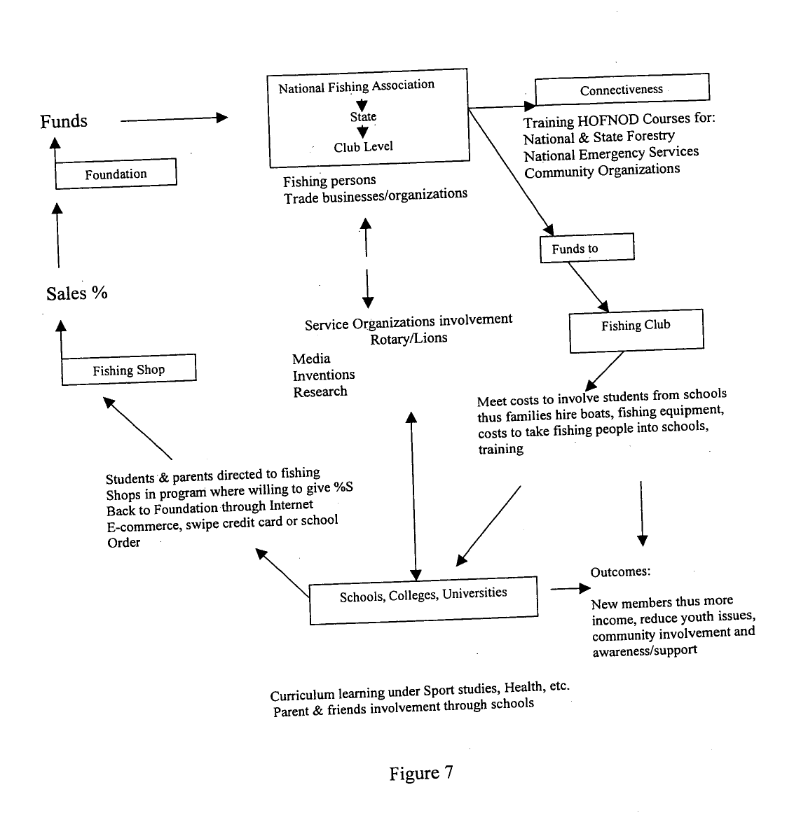

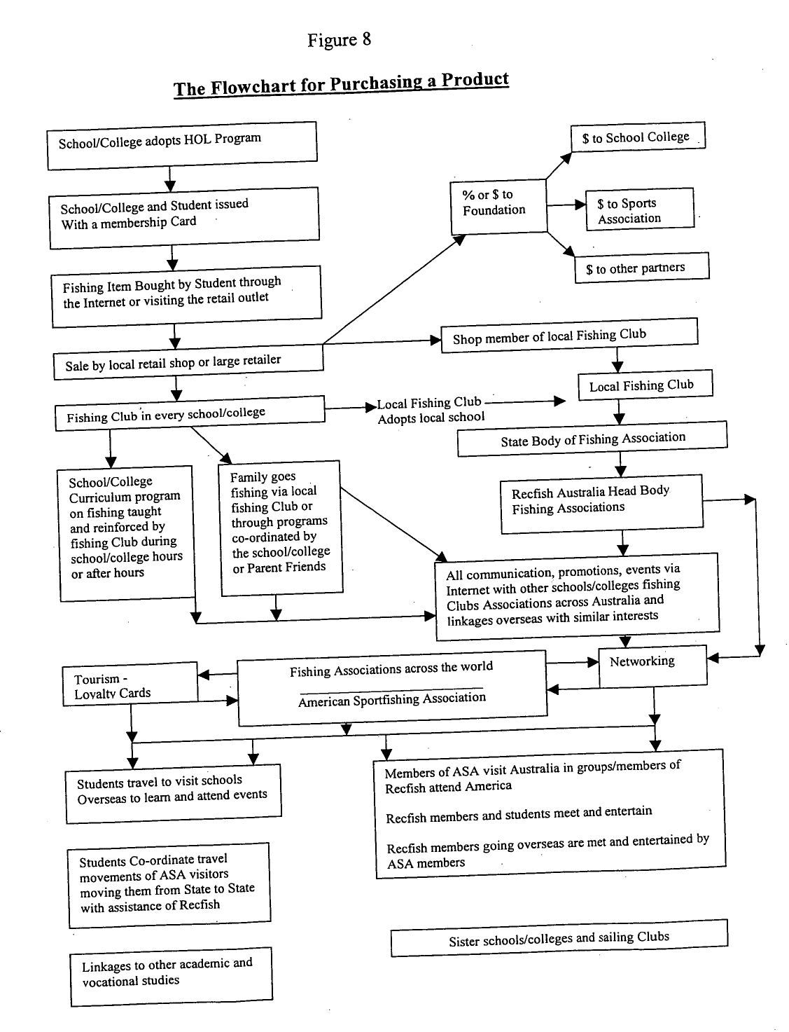

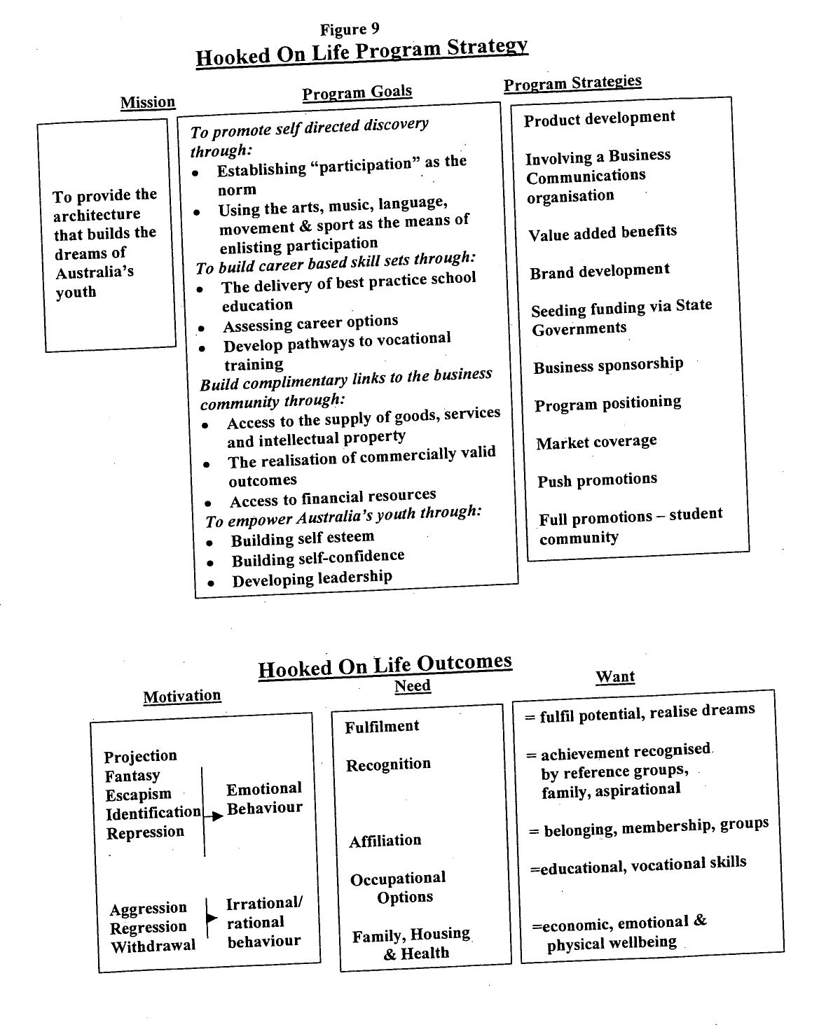

As an example of the process, a flowchart for the purchase of a sponsored product is illustrated in FIG. 6.

1. A method of structuring a program for developing in a group of students a set of life management skills, the method comprising:
providing a board to manage the program, the board managing a funding sub-program including coordination of acquiring funds for operating the program from at least one source selected from a group of sponsors, the group including educational institutions, sporting organizations, business organizations, service organizations, recreational organizations, and governmental funding sources;
providing one or more activities for the students, the activities including at least one activity selected from the group of a physical activity and an intellectual activity, the at least one activity made available by at least one source selected from a group of activity providers, the group including educational institutions, sporting organizations, business organizations, service organizations, recreational organizations, and external training providers,
wherein the funding sub-program includes encouraging the students in connection with the activity to purchase goods or services from at least one of the sponsors and activity providers.

2. The method of structuring the program of claim 1, further wherein a portion of sales revenues from purchases of goods or services by students are contributed by the sponsors and activity providers to the board for the program.

3. The method of structuring the program of claim 1, wherein the board manages a youth club sub-program.

4. The method of structuring the program of claim 3, wherein the youth club sub-program includes production of a television show.

5. The method of structuring the program of claim 3, wherein the youth club sub-program includes publishing a magazine.

6. The method of structuring the program of claim 3, wherein the youth club sub-program includes producing a computer-network based program.

7. The method of structuring the program of claim 1, further comprising the step of providing at least one board of advisers for advising the managing board, the board of advisers including members having expertise in at least one of the activities provided to the students.

8. The method of structuring the program of claim 1, further comprising the steps of recruiting a plurality of volunteers and training the volunteers to coach the students in the at least one activity.

9. The method of structuring the program of claim 1, wherein the at least one activity includes recreational fishing, the activity including coaching students in fishing-related knowledge and skills.

10. The method of structuring the program of claim 9, further comprising the steps of recruiting a plurality of volunteers and training the volunteers to coach the students in recreational fishing.

11. The method of structuring the program of claim 1, wherein the at least one activity includes an intellectual activity wherein the students apply inventive thinking skills in a business setting to develop new products.

12. The method of structuring the program of claim 11, wherein a business organization provides one or more employees to act as mentors to students in applying inventive thinking skills to develop new products.

13. A method of structuring a program for developing in a group of students a set of life management skills, the method comprising:
providing a board to manage the program, the board managing a funding sub-program including coordination of acquiring funds for operating the program from at least one source selected from a group of sponsors, the group including educational institutions, sporting organizations, business organizations, service organizations, recreational organizations, and governmental funding sources;.
providing one or more activities for the students, the activities including at least one activity selected from the group of a physical activity and an intellectual activity, the at least one activity made available by at least one source selected from a group of activity providers, the group including educational institutions, sporting organizations, business organizations, service organizations, recreational organizations, and external training providers,
wherein a portion of sales revenues from purchases of goods or services by students from the sponsors and the activity providers are to be contributed to the board for the program.

14. The method of structuring the program of claim 13 wherein the funding sub-program includes encouraging the students in connection with the activity to purchase the goods or services of at least one of the sponsors and activity providers.

15. The method of structuring the program of claim 13, wherein the board manages a youth club sub-program, and wherein the youth club includes at least one activity selected from the group of producing a television show, publishing a magazine, and producing a computer-network based program.

16. The method of structuring the program of claim 13, further comprising the step of providing at least one board of advisers for advising the managing board, the board of advisers including members having expertise in at least one of the activities provided to the students.

17. The method of structuring the program of claim 13, further comprising the steps of recruiting a plurality of volunteers and training the volunteers to coach the students in the at least one activity.

18. The method of structuring the program of claim 13, wherein the at least one activity includes recreational fishing, the activity including coaching students in fishing-related knowledge and skills.

19. The method of structuring the program of claim 18, further comprising the steps of recruiting a plurality of volunteers and training the volunteers to coach the students in recreational fishing.

20. The method of structuring the program of claim 13, wherein the at least one activity includes an intellectual activity wherein the students apply inventive thinking skills in a business setting to develop new products.

21. The method of structuring the program of claim 20, wherein a business organization provides one or more employees to act as mentors to students in applying inventive thinking skills to develop new products.

22. A method of structuring a program for developing in a group of students a set of life management skills, the method comprising:
providing a board to manage the program, the board managing a funding sub-program including coordination of acquiring funds for operating the program from at least one source selected from a group of sponsors, the group including educational institutions, sporting organizations, business organizations, service organizations, recreational organizations, and governmental funding sources;
providing one or more activities for the students, the activities including at least one activity selected from the group of a physical activity and an intellectual activity, the at least one activity made available by at least one source selected from a group of activity providers, the group including educational institutions, sporting organizations, business organizations, service organizations, recreational organizations, and external training providers,
wherein the funding sub-program includes encouraging the students in connection with the activity to purchase the goods or services of at least one of the sponsors and activity providers, and wherein a portion of sales revenues from purchases of goods or services by students are contributed by the sponsors and activity providers to the board for the program.

23. A method of structuring a program for developing in a group of students a set of life management skills, the method comprising:
providing one or more activities for the students, the activities including at least one activity selected from the group of a physical activity and an intellectual activity, the at least one activity made available by a business organization, wherein the students are encouraged in connection with the activity to purchase goods or services from the business organization.

24. The method of claim 23 wherein the business organization contributes to the program a portion of sales revenues attributable to the students.

25. A method of structuring a program for developing in a group of students a set of life management skills, the method comprising:
providing a board to manage the program, the board managing a funding sub-program including coordination of acquiring funds for operating the program from at least one source selected from a group of sponsors, the group including educational institutions, sporting organizations, business organizations, service organizations, recreational organizations, and governmental funding sources;
providing a youth club sub-program for the students; and
providing one or more activities for the students, the activities including at least one activity selected from the group of a physical activity and an intellectual activity, the at least one activity made available by at least one source selected from a group of activity providers, the group including educational institutions, sporting organizations, business organizations, service organizations, recreational organizations, and external training providers.

26. The method of structuring the program of claim 25 wherein the youth club sub-program includes at least one activity selected from the group of producing a television show, publishing a magazine, and producing a computer-network based program.

27. The method of structuring the program of claim 25 wherein the funding sub-program includes encouraging the students in connection with the activity to purchase the goods or services of at least one of the sponsors and activity providers, and wherein a portion of sales revenues from purchases of goods or services by students are to be contributed to the board for the program.

28. A method of structuring a program for developing in a group of students a set of life management skills, the method comprising:
providing a board to manage the program, the board managing a funding sub-program;
providing one or more activities for the students, the activities including at least one activity selected from the group of a physical activity and an intellectual activity, the at least one activity made available by at least one source selected from a group of activity providers, the group including educational institutions, sporting organizations, business organizations, service organizations, recreational organizations, and external training providers,
wherein the funding sub-program includes providing each student with a membership card to be presented when the student purchases goods or services from one of the activity providers to facilitate the activity providers' contributing a portion of sales revenues from purchases of goods or services by students to the board for the program.
